(19) United States
(12) Patent Application Publication
(10) Pub. No.: US 2022/0391250 A1
(43) Pub. Date: Dec. 8, 2022

(54) VIRTUAL EXECUTION ENVIRONMENT POWER USAGE

(71) Applicant: Intel Corporation, Santa Clara, CA (US)

(72) Inventors: John J. BROWNE, Limerick (IE); Chris MACNAMARA, Limerick (IE)

(21) Appl. No.: 17/891,916

(22) Filed: Aug. 19, 2022

(51) Int. Cl. G06F 9/48; G06F 9/455

(52) U.S. Cl. CPC G06F 9/4893; G06F 9/45558; G06F 2009/45595

(57) ABSTRACT

Examples described herein relate to determination of per-virtualized execution environment power usage based on an identifier of a processor that executes at least two virtualized execution environments, power usage of the processor, and number of virtualized execution environments executed by the processor.

Carbon use is a global issue and is potentially linked to damage to the environment. Cloud computing and networking devices utilize carbon-based power and contribute to the carbon footprint. Cloud service providers (CSPs) deploy applications into a cloud account to track the carbon footprint of their applications. CSPs report carbon footprint to regulators and shareholders as part of sustainability and power reduction initiatives.

### BRIEF DESCRIPTION OF THE DRAWINGS

FIG. 1 depicts an example system.

FIG. 2 depicts an example of virtual environment executions.

FIG. 3 depicts an example of a system that determines virtual machine power usage.

FIG. 4 depicts an example of power estimation for bare metal executions of containers.

FIG. 5 depicts an example of reporting.

FIG. 6 depicts an example process.

FIG. 7 depicts an example computing system.

FIG. 8 depicts an example computing system.

### DETAILED DESCRIPTION

At least to determine per-virtual machine (VM) or per-container power usage, a telemetry reporting service or device can determine data related to power usage of one or more processors to execute VMs or containers, utilization levels of processors from performance of the VMs or containers, identifier of processors utilized to execute the VMs or containers (e.g., stock-keeping unit (SKU)), or number of VMs or containers executed by a processor. The telemetry reporting service or device can report the data to a power monitoring and analytics service or device. The power monitoring and analytics service or device can determine per-VM or per-container power usage based on power utilization by instruction-executing devices of the processors (e.g., cores) and number of VMs or containers execution on the instruction-executing devices. In some examples, per-VM or per-container power usage can be determined for VMs and containers running in VMs, or VMs and containers running on bare metal platforms.

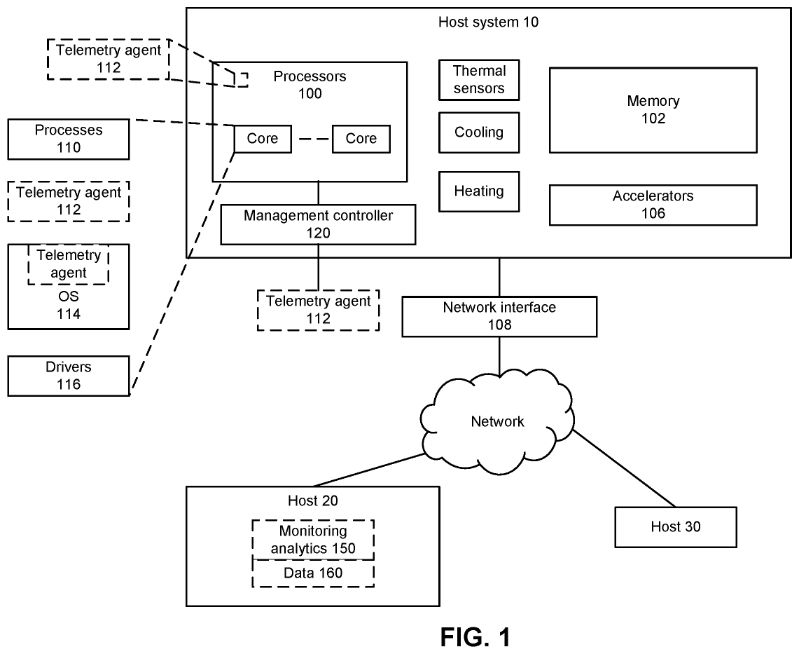

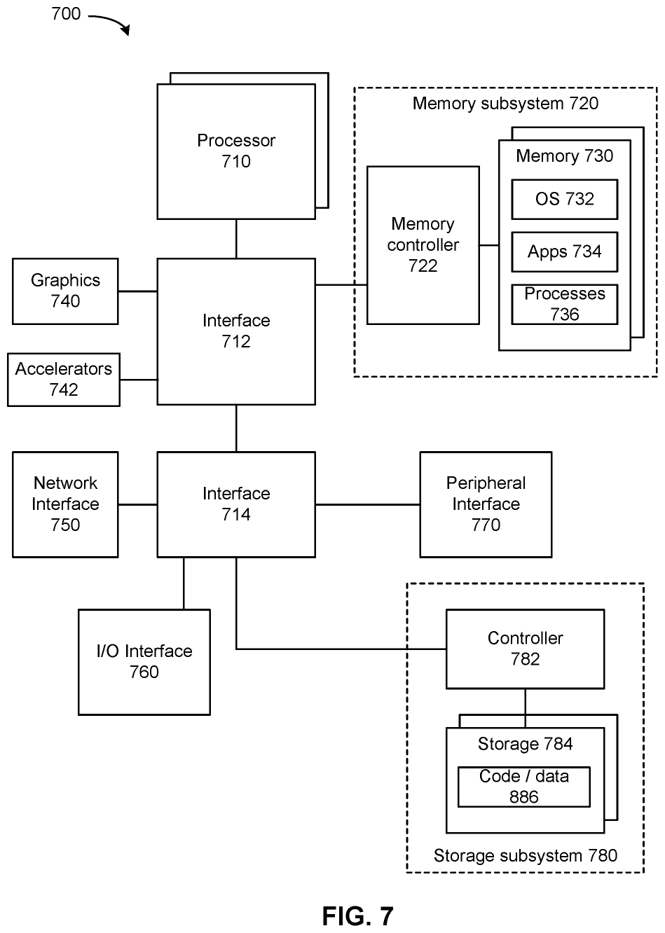

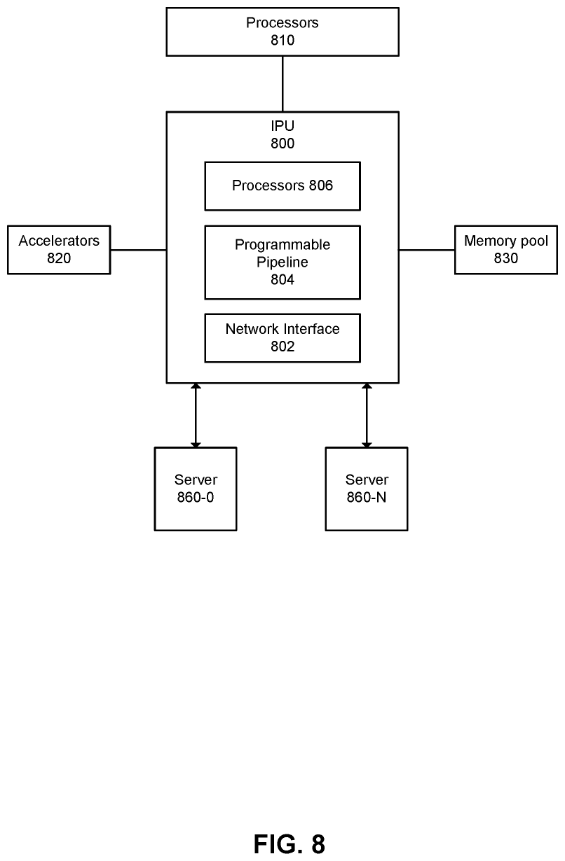

FIG. 1 depicts an example system. Host system 10 can include processors 100 that execute one or more of processes 110, operating system (OS) 114, device driver 116, as well as other software. Various examples of hardware and software utilized by the host system are described at least with respect to FIGS. 7 and 8. For example, processors 100 can include a CPU, graphics processing unit (GPU), accelerator, or other processors described herein. Processes 110 can include one or more of: an application, a process, a thread, a virtual machine (VM), microVM, a container, a microservice, or other virtualized execution environment.

Various examples of processes 110 can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. In some examples, EPC is a 3GPP-specified core architecture at least for Long Term Evolution (LTE) access. 5G network slicing can provide for multiplexing of virtualized and independent logical networks on the same physical network infrastructure. Some example implementations of NFV are described in ETSI specifications or Open Source NFV MANO from ETSI's Open Source Mano (OSM) group. Processes 110 can include virtual network function (VNF), such as a service chain or sequence of virtualized tasks executed on generic configurable hardware such as firewalls, domain name system (DNS), caching or network address translation (NAT) and can run in virtual execution environments. VNFs can be linked together as a service chain. Processes 110 can include a cloud native network function (CNF), which can include a network function that executes inside a container. Some processes 110 can perform video processing or media transcoding (e.g., changing the encoding of audio, image or video files).

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

Processes 110 can include a Cloud-Native Network Function (CNF), which can include a software-implementation of a network function, which runs inside Linux containers and can be orchestrated by Kubernetes. CNFs can include containerized microservices that communicate with one another via standardized RESTful application program interfaces (APIs). In European Telecommunications Standards Institute (ETSI) NFV standards, CNFs are a particular type of VNF and can be orchestrated as VNFs using the ETSI NFV MANO architecture and technology-agnostic descriptors (e.g., TOSCA, YANG).

As described herein, telemetry agent 112 can access processor power utilization information and provide the processor power utilization information to monitoring analytics 150 executed by host 20. For example, processor power utilization information from telemetry agent 112 can be received by monitoring analytics 150 periodically (e.g., at an interval of 5-10 seconds). Power utilization information can be discarded if the VM or container moved cores to account for non-pinned workloads. Various examples of processor power utilization information can include processor stock-keeping unit (SKU) information that identifies a processor manufacturer and type and can be used by monitoring analytics 150 to determine a number of cores in a processor and a thermal design power (TDP) of the processor. Various examples of processor power utilization information can include utilization data. For example, utilization data can include power utilization (e.g., watts) or core utilization percentage over a duration of time. Various examples of processor power utilization information can include a number of virtual machines or containers executed by cores of processors 100. In some examples, telemetry agent 112 can utilize a virtualization API such as libvirt, Docker cadvisor, or Prometheus exportor agent to determine processor power utilization information and provide processor power utilization information to monitoring analytics 150.

In some examples, telemetry agent 112 can be implemented as processor-executed software or firmware (e.g., by one or more cores of processors 100). In some examples, telemetry agent 112 can be integrated into OS 114. In some examples, telemetry agent 112 can be implemented as circuitry (e.g., application specific integrated circuit (ASIC) or field programmable gate array (FPGA)) in host system 10. In some examples, telemetry agent 112 can be implemented as circuitry or processor-executed software or firmware accessible through a management controller 120.

In some examples, management controller 120 can provide telemetry agent 112 access to processor power utilization information. Management controller 120 can be implemented as one or more of: Board Management Controller (BMC), Intel® Management or Manageability Engine (ME), or other devices.

Drivers 116 can provide processes 110 or OS 114 with communication to and from and utilization of accelerators 106, network interface 108, or other devices. Network interface 108 can receive packets directed to processes 102 and transmit packets at the request of processes 102. Network interface 108 can refer to one or more of the following examples: a data processing unit (DPU), infrastructure processing unit (IPU), smartNlC, forwarding element, router, switch, network interface controller, network-attached appliance (e.g., storage, memory, accelerator, processors, security), and so forth. For example, network interface 108 can transmit processor power utilization information from telemetry agent 112 to monitoring analytics 150.

Monitoring analytics 150 can issue an application program interface (API) to telemetry agent 112 to request processor power utilization information. Monitoring analytics 150 can receive processor power utilization information at host system 20 via network-based communications. Monitoring analytics 150 can be implemented on host system 10. Monitoring analytics 150 can calculate or determine power utilization per VM or container by determining per-core power utilization and based on number of VMs or containers executed by the processor by considering processor utilization information, number of VMs or containers executed by the processor, processor power use, processor SKU ID, or other information. For example, based on data 160 such as processor SKU ID, monitoring analytics 150 can determine a number of cores in a processor that executes VMs or containers and is monitored by telemetry agent 112. Based on a number of cores in the processor, monitoring analytics 150 can determine allocation of processor power use (e.g., TDP) among cores to determine per-core power use. Based on a number of VMs or containers executed by the processor, monitoring analytics 150 can determine per-VM or per-container power usage.

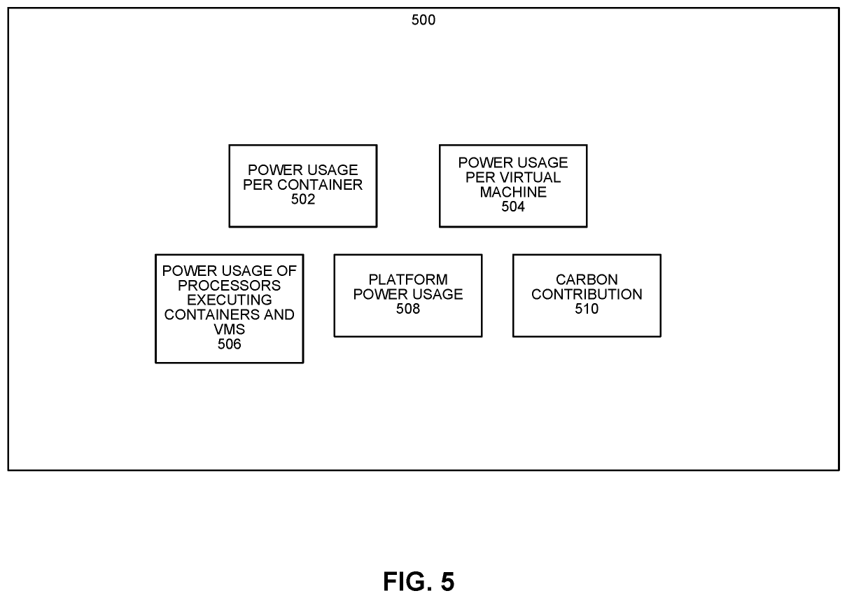

Monitoring analytics 150 can provide a graphical user interface (GUI) to display carbon usage data for VMs and containers for auditing and reporting purposes to indicate a carbon footprint. An example of information displayed is described with respect to FIG. 5. Monitoring analytics 150 can perform orchestration to attempt to reduce power consumption of managed processor cores based on the determined power usage for VMs and containers.

While examples are described with respect to CPUs, per-VM or per-container power usage can be determined for execution on processors such as graphics processing units (GPUs), general purpose GPUs (GPGPUs), Infrastructure Processing Unit (IPUs), data processing units (DPUs), accelerators, or other processors, and so forth.

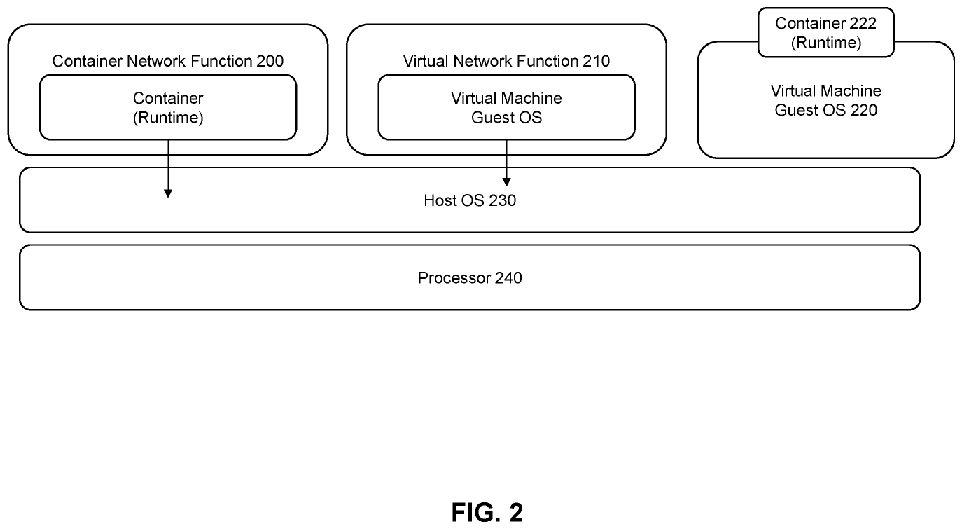

FIG. 2 depicts an example of executions of virtual execution environments. For example, a container network function (CNF) 200 can be implemented as a container and host operating system (OS) 230 executed by processor 240 provides CNF 200 access to various hardware devices and software. For example, a virtual network function (VNF) 210 can be implemented as a virtual machine with a guest OS and host OS 230 executed by processor 240 provides VNF 210 access to various hardware devices and software. For example, in a bare metal scenario, in which a physical computer server is dedicated to a single tenant, one or more instances of virtual machine with a guest OS 220 can access host OS 230 and processor 240. In some cases, in the bare metal scenario, the virtual machine with a guest OS 220 can execute one or more instances of container 222.

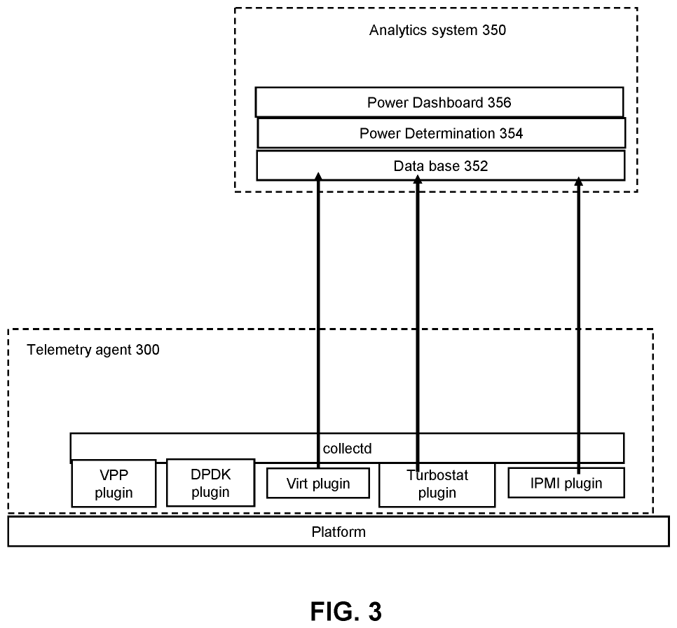

FIG. 3 depicts an example of a system of software that determines virtual machine power usage. A Kubernetes Virt plugin, available from RedHat or under a GPLv2 license, can provide an inventory that includes one or more of: list of guests (e.g., VMs and containers) and identification of which physical CPUs execute the guests. In some examples, use of a Linux virt_top command with “−1” can cause retrieval of physical CPU utilization and percentage of the physical CPU used by a virtual execution environment and the hypervisor together and percentage used by just the virtual execution environment. Workloads of VMs and containers can be pinned or non-pinned. The Linux® Turbostat plugin can read power data of CPUs. The Linux® Turbostat plugin can be based on a turbostat tool of the Linux® kernel. Power data can include one or more of: CPU power utilization, core frequency, core residency (e.g., a percent of time a core spends in a reduced power consumption state), uncore frequency, CPU SKU ID, power state (e.g., C-state) residency of CPUs, or other information.

Intelligent Platform Management Interface (IPMI) plugin or other plugin can provide management and monitoring capabilities of the CPU, firmware (e.g., BIOS or UEFI) or other features. IPMI plugin can provide platform data such as one or more of: power supply unit (PSU) provides power level, sensor information including per-core temperature, fan speed data, or other information.

Analytics system 350 can determine power usage per VM or container based on power data received from telemetry agent 300. Time series data base 352 can receive power data from telemetry agent 300. In some examples, time series data base 352 can include Prometheus. Analytics system 350 can perform power determination based on data in a time series data base on different server than that of server that runs VMs. Analytics system 350 can perform power determination local to platform and exclude core that performs analytics system 350 or backs out power used by analytics system 350 to determine power usage per-VM or per-container.

Power determination 354 can determine power usage per-VM or per-container. Various examples of power determination for non-polling and polling workloads (e.g., Data Plane Development Kit (DPDK) based workloads) executed in VMs are described next. Power determination 354 can determine power consumed by one or more physical core based on one or more of: list of VMs and the physical cores that execute VMs, CPU power consumption, SKU ID, physical per core frequency, utilization per physical core, or other factors or data. Power determination 354 can determine per-VM power usage based on number of VMs executing on a physical core and power utilization of the physical core.

For example, power estimation function calculation can vary from different SKU IDs and between generations of processors. Power determination 354 can access a table per SKU ID that indicates a TDP or power usage of a processor and percentage allocation of TDP or power usage to an uncore and to instruction-executing cores. For example, for a particular SKU ID, a TDP can specified be 185 Watts over an interval of time for 32 cores, uncore TDP allocation can specified be to 40%, and core TDP allocation can specified be to 60%. As cores take 60% of TDP, the average power per core is 60% of TDP (111 Watts) and 3.5 watts is utilized per core. Telemetry agent 300 provided CPU utilization over a time duration provides per-core utilization of 70% over the time period. For example, for 2 GHz CPU, utilization of 70% means 70% of 2 GHz clock cycles are used (1.4 GHz).

Using utilization as a load factor, when a given core is at utilization of 70%, an estimated power usage is 2.5 watts per core. There can be a power floor per non-utilized core and such power floor can be non-zero watts, however power consumption of a non-utilized core can be zero watts. Power per-VM per-core can be determined by dividing power per core by number of active VMs. For VMs executed on shared physical cores, use of percentage of utilization can be used to apportion power to VMs. Examples of shared physical cores includes hyperthreaded cores, where a physical core includes two or more hyperthreads and different VMs run on different hyperthreads. The operating system or other software or device may refer to hyperthreads as virtual CPUs. When multiple VMs run on the same hyperthread, on the same physical core, the utilization of the hyperthread per-VM can be used to apportion power. The estimated usage of 2.5 watts per-core can be divided by number of VMs executing on a core reported by telemetry agent to determine per-VM power usage. For example, for 64 VMs executing on cores, the average per-VM power usage can be 1.25 W.

Power dashboard 356 can provide a visual representation of power usage per-VM. For example, power dashboard 356 can utilize an open source analytics and interactive visualization web application such as Grafana. Grafana provides charts, graphs, and alerts for the web when connected to a supported data source.

The following describes example power determination operations for VMs that do not perform polling workloads. At (1), telemetry agent 300 can report identified guest VMs and utilization and physical core IDs using virt plugin software. At (2), telemetry agent 300 reports utilization of CPU for duration of execution of at least one VM. At (3), telemetry agent 300 (e.g., Turbostat) reports power measurements per CPU. For example, Turbostat can measure core frequency and core power state residency (e.g., length of time a core is in a reduced power state). At (3), an IPMI plugin can collect the platform data. In other examples, a Redfish plugin can collect the platform data. Other telemetry agent collection interfaces to the operating system can be used to collect platform data. For example, Collectd can provide data gathered in (1)-(3) to analytics system 350. Collectd can tag gathered data with CPU SKU IDs or CPU SKU IDs. Other telemetry collection agents can provide data gathered in (1)-(3) to analytics system 350. Examples of telemetry collection agents include Telegraf, statsD, or telemetry collection software from VMware.

At (4), monitoring analytics can estimate power consumption per guest VM by determining power use per core and assigning power usage to VMs assigned to those cores based on a combination of CPU utilization, core count, VMs assigned to execute on the CPU, and power consumed.

The following describes example power usage determination operations for VMs that perform polling workloads (e.g., workloads based on DPDK). At (1), telemetry agent 300 can report identified guest VMs and utilization and physical core IDs using virt plugin software. At (2), a DPDK application (e.g., Vector Packet Processing (VPP) plugin and DPDK plugin) can report a busyness indication of a CPU to perform a polling workload (e.g., percentage) over time. At (3), telemetry agent 300 (e.g., Turbostat) reports power measurements per CPU. For example, Turbostat can measure core frequency and core power state residency (e.g., length of time in a reduced power state). At (3), an IPMI plugin can collect the platform data. For polling workloads, Telegraf can provide data gathered in (1)-(3) to analytics system 350. Telegraf can tag gathered data with CPU SKU IDs or CPU SKU IDs. Other telemetry collection agents can be used, such as: collectd, statsD, or telemetry collection software from VMware.

At (4), monitoring analytics can estimate power consumption per guest VMs that perform a polling workload by determining power use per core and assigning power usage to VMs assigned to those cores based on a combination of CPU utilization, core count, VMs assigned to execute on the CPU, and power consumed.

The following describes an example manner to determine power usage by containers executing in VMs. To estimate power for multiple containers running in a single VM, the following operations can be performed. At (1), the VM executes Docker cadvisor telemetry agent (e.g., https://hub.docker.com/r/google/cadvisor/) which can report one or more of: a list of containers executed in the VM, virtual CPU identifiers of containers operating within the VM, processor utilization of the containers, or other information. Telemetry agent 300 can utilize the information from cadvisor as well other information provided by virt plugin, Turbostat plugin, and IPMI plugin (or alternatives) described earlier. Analytics system 350 can map container names with a VM to a list of virtual CPUs and physical CPUs and can calculate power usage per container by calculating the power usage per physical core and allocating power usage per physical core to containers assigned to the physical core. Referring back to the earlier example, for estimated usage of 2.5 watts per-core and 10 executed containers, power usage per container by 0.25 W.

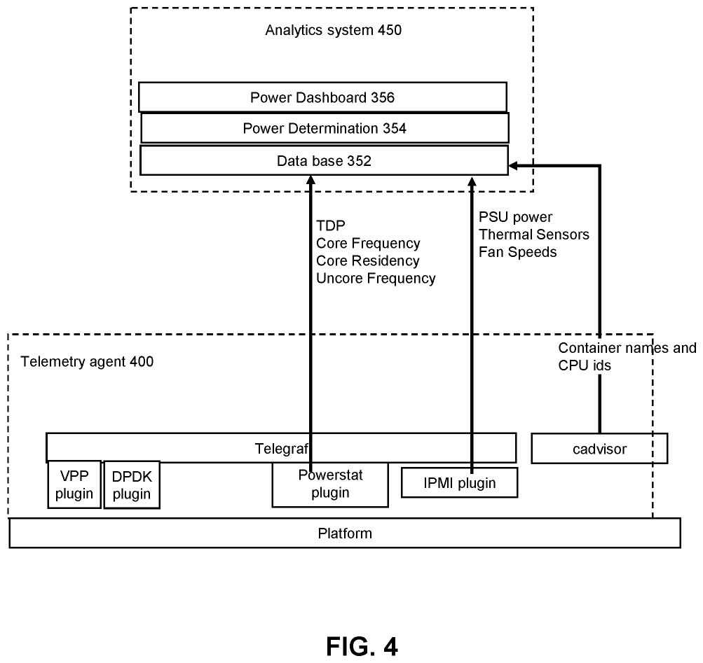

FIG. 4 depicts an example of power estimation for bare metal executions of containers utilizing a host OS instead of within a VM. Telemetry agent 400 can utilize Intel® PowerStat Input Plugin to provide one or more of: TDP, core frequency, core residency (e.g., percent or amount of time a core is in a reduced power consumption state), or uncore frequency to analytics system 450. Telemetry agent 400 can IPMI plugin to provide one or more of PSU power usage, thermal sensor values (e.g., per-core temperature), and fan speeds to analytics system 450. Telemetry agent 400 can utilize cadvisor to provide one or more of container names and CPU identifiers to analytics system 450.

Analytics system 450 can receive from telemetry agent 400 at least a list of containers and the physical cores that execute the containers. Analytics system 450 can receive from telemetry agent 400 one or more of: CPU power consumption, SKU ids, per-physical core frequency, utilization per physical core, or other information. Analytics system 450 can use power information (e.g., CPU power consumption, SKU ID, per-physical core frequency, and utilization per physical core, or other information) to determine how much power is consumed by physical cores executing containers. Analytics system 450 can associate power per core with the containers assigned to those cores and determine power per container (e.g., CNF) by dividing power per core by number of cores executing on the core.

For example, power usage determination for non-polling workloads executed in containers running in a bare metal environment on host OS and not in a VM can be as follows. At (1), a cAdvisor can report container names, utilization and physical cores IDs. At (2), telemetry agent 400 can report power utilization measurements over an interval of time from Powerstat per physical core (if available) and power utilization measurements over an interval of time of CPU and platform using IPMI. Such power utilization measurements can be associated with a SKU ID of one or more physical cores. Per-core power usage can be determined as described earlier. At (3), analytics system 450 can determine power consumption per container by dividing per-core power usage by number of containers executed per core.

For example, power determination for polling workloads executed in containers running in a bare metal environment on host OS and not in a VM can be as follows. At (1), cAdvisor can report container names, utilization, and physical cores IDs. At (2), telemetry agent 400 can report power utilization measurements over an interval of time from Powerstat per physical core (if available) and power utilization measurements over an interval of time of CPU and platform using IPMI. At (3), DPDK plugin and VPP plugin can provide busyness indications of containers to analytics system 450. Such information provided in (1)-(3) can be associated with a SKU ID of one or more physical cores. At (4), analytics system 450 can determine power consumption per container by dividing per-core power usage by number of containers executed per core.

While specific examples of software plugins and libraries are recited, other software and/or hardware can be utilized.

FIG. 5 depicts an example manner of power and carbon reporting. In a graphical user interface 500, one or more of the following can be reported visually: power usage per container 502, power usage per virtual machine 504, power usage of processors executing containers and VMs 506, platform power usage 508, and carbon contribution or utilization per VM or container 510. In some examples, information displayed in graphical user interface 500 can be provided in a file or data base for retrieval by an administrator, CSP, or orchestrator. In some examples, an orchestrator can utilize per-VM or per-container power usage to determine whether to reduce platform power usage or migrate VMs or containers to lower power environments to reduce carbon utilization. Other information can be provided such as number of executed containers or VMs.

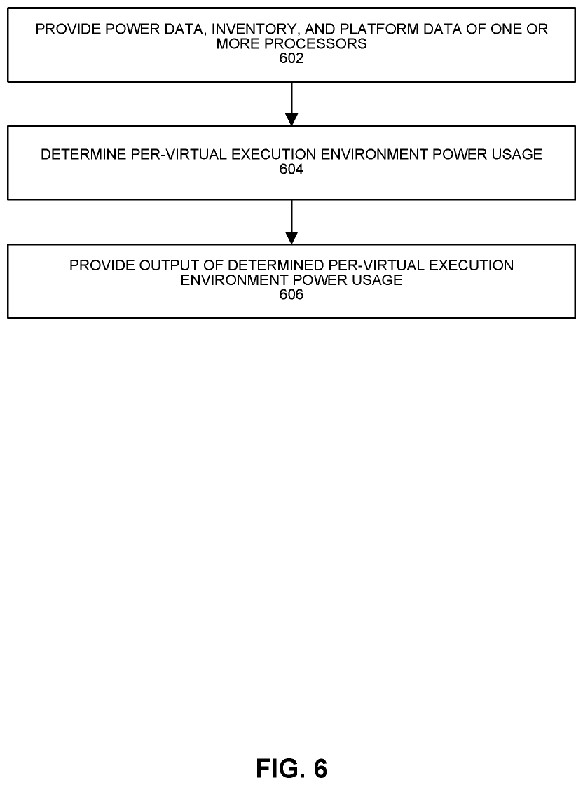

FIG. 6 depicts an example process. At 602, for a monitored CPU or CPUs, a telemetry agent can provide indications of power data, inventory, and platform data to an analytics monitor. Power data can include one or more of: power consumption by a CPU over a time window, core frequency, core residency, uncore frequency, tag for CPU SKU or ID if power estimation method changes with generation or type of SKU. Inventory can include one or more of: list of guests (e.g., VMs and containers) and what physical CPUs execute the guests. Platform data such as one or more of: PSU power, thermal sensor data (e.g., temperature of one or more cores), and fan speeds.

At 604, the analytics monitor can determine per-VM or per-container power usage. For example, the analytics monitor can determine utilization of power core power percentage based on SKU identifier of processors. Based on core power utilization percentage and received power consumption of the CPU, the analytics monitor can determine per-core power consumption of the received power consumption of the CPU. Based on the determined per-core power consumption and inventory of number of VMs or containers executing on the CPU, the analytics monitor can determine per-VM or per-container power usage.

At 606, the analytics monitor can provide an output of per-VM or per-container power usage. For example, the analytics monitor can cause the per-VM or per-container power usage to be displayed in a graphics user interface (GUI) or output in a file.

FIG. 7 depicts an example computing system. Components of system 700 (e.g., processor 710, accelerators 742, and so forth) to perform detection of power usage per-VM or per-container by execution of a telemetry agent or analytics system or both, as described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function or programmable offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM

(SDRAM). An example of a volatile memory include a cache.

A non-volatile memory (NVM) device is a memory whose state is determinate even if power is interrupted to the device. In one embodiment, the NVM device can comprise a block addressable memory device, such as NAND technologies. A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of one or more of the above, or other memory.

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chip-to-chip communications, die-to-die communications, packet-based communications, communications over a device interface, fabric-based communications, and so forth. A die-to-die communications can be consistent with Embedded Multi-Die Interconnect Bridge (EMIB).

FIG. 8 depicts an example system. In this system, IPU 800 manages performance of one or more processes using one or more of processors 806, processors 810, accelerators 820, memory pool 830, or servers 840-0 to 840-N, where N is an integer of 1 or more. In some examples, processors 806 of IPU 800 can execute one or more processes, applications, VMs, containers, microservices, and so forth that request performance of workloads by one or more of: processors 810, accelerators 820, memory pool 830, and/or servers 840-0 to 840-N. IPU 800 can utilize network interface 802 or one or more device interfaces to communicate with processors 810, accelerators 820, memory pool 830, and/or servers 840-0 to 840-N. IPU 800 can utilize programmable pipeline 804 to process packets that are to be transmitted from network interface 802 or packets received from network interface 802. Programmable pipeline 804 and/or processors 806 can be configured to perform detection of power usage per-VM or per-container by execution of a telemetry agent or analytics system or both, as described herein.

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade can include components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nano station (e.g., for Point-to-MultiPoint (PtMP) applications), micro data center, on-premise data centers, off-premise data centers, edge network elements, fog network elements, and/or hybrid data centers (e.g., data center that use virtualization, serverless computing systems (e.g., Amazon Web Services (AWS) Lambda), content delivery networks (CDN), cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or combination thereof, including “X, Y, and/or Z.”′

Illustrative examples of the devices, systems, and methods disclosed herein are provided below. An embodiment of the devices, systems, and methods may include one or more, and combination of, the examples described below.

Example 1 includes at least one non-transitory computer-readable medium comprising instructions stored thereon, that if executed by one or more processors, cause the one or more processors to: receive power usage data of a platform, the power usage data comprising an identifier of a processor that executes at least two virtualized execution environments, power usage of the processor, and number of virtualized execution environments executed by the processor, wherein at least one virtualized execution environment of the at least two virtualized execution environments comprises a virtual machine and/or container and wherein the at least one virtualized execution environment is to execute a virtualized network function; determine power usage per virtualized execution environment executing on the processor based on the power usage data; and output the power usage per virtualized execution environment executing on the processor.

Example 2 includes one or more examples, wherein the power usage data comprises one or more of: power usage of one or more processors, processor utilization by a workload, processor stock-keeping unit (SKU) identifier, or identifiers of virtualized execution environments that execute on at least one physical processor.

Example 3 includes one or more examples, wherein the power usage data comprises one or more of: supplied power, temperature, or fan speeds.

Example 4 includes one or more examples, and includes wherein the determine power usage per virtualized execution environment executing on the processor based on the power usage data comprises: access data indicative of power allocation in the processor to instruction-executing cores and determine per-core power usage based on the power usage of one or more processors and the power allocation in the processor to instruction-executing cores.

Example 5 includes one or more examples, wherein the determine power usage per virtualized execution environment executing on the processor based on the power usage data comprises: determine per virtualized execution environment based on the determined per-core power usage and the number of virtualized execution environments executed by the processor.

Example 6 includes one or more examples, wherein the processor comprises one or more of: central processing unit (CPU), graphics processing unit (GPU), or accelerator.

Example 7 includes one or more examples, wherein the output the power usage per virtualized execution environment executing on the processor comprises cause display in a graphics user interface of the power usage per virtualized execution environment executing on the processor and one or more of: carbon usage of the at least two virtualized execution environments, power usage by the at least two virtualized execution environments, or number of executed virtualized execution environments.

Example 8 includes one or more examples, wherein the at least two virtualized execution environments comprise a virtual network function (VNF) or a cloud native network function (CNF).

Example 9 includes one or more examples, and includes an apparatus comprising: a memory and at least one processor, that based on execution of at least one instruction stored in the memory, is to: access power usage data of a platform, the power usage data comprising an identifier of a processor that executes at least two virtualized execution environments, power usage of the processor, and number of virtualized execution environments executed by the processor, wherein at least one virtualized execution environment of the at least two virtualized execution environments comprises a virtual machine and/or container and wherein the at least one virtualized execution environment is to execute a virtualized network function; determine power usage per virtual execution environment executing on the processor based on the power usage data; and output the power usage per virtual execution environment executing on the processor.

Example 10 includes one or more examples, wherein the power usage data comprises one or more of: power usage of one or more processors, processor utilization by a workload, processor stock-keeping unit (SKU) identifier, or identifiers of virtualized execution environments that execute on at least one physical processor.

Example 11 includes one or more examples, wherein the power usage data comprises one or more of: supplied power, temperature, or fan speeds.

Example 12 includes one or more examples, wherein the determine power usage per virtualized execution environment executing on the processor based on the power usage data comprises: access data indicative of power allocation in the processor to instruction-executing cores and determine per-core power usage based on the power usage of one or more processors and the power allocation in the processor to instruction-executing cores.

Example 13 includes one or more examples, wherein the determine power usage per virtualized execution environment executing on the processor based on the power usage data comprises: determine per virtualized execution environment based on the determined per-core power usage and the number of virtualized execution environments executed by the processor.

Example 14 includes one or more examples, wherein the processor comprises one or more of: central processing unit (CPU), graphics processing unit (GPU), or accelerator.

Example 15 includes one or more examples, wherein the output the power usage per virtualized execution environment executing on the processor comprises cause display in a graphics user interface of the power usage per virtualized execution environment executing on the processor and one or more of: carbon usage of the virtualized execution environments, power usage by the virtualized execution environments, or number executed virtualized execution environments.

Example 16 includes one or more examples, wherein the virtualized execution environments comprise a virtual network function (VNF) or a cloud native network function (CNF).

Example 17 includes one or more examples, and includes a method comprising: accessing power usage data of a platform, the power usage data comprising an identifier of a processor that executes at least two virtualized execution environments, power usage of the processor, and number of virtualized execution environments executed by the processor, wherein at least one virtualized execution environment of the at least two virtualized execution environments comprises a virtual machine and/or container and wherein the at least one virtualized execution environment executes a virtualized network function; determining power usage per virtualized execution environment executing on the processor based on the power usage data; and providing the power usage per virtualized execution environment executing on the processor.

Example 18 includes one or more examples, wherein the power usage data comprises one or more of: power usage of one or more processors, processor utilization by a workload, processor stock-keeping unit (SKU) identifier, or identifiers of virtualized execution environments that execute on at least one physical processor.

Example 19 includes one or more examples, wherein the determining power usage per virtualized execution environment executing on the processor based on the power usage data comprises: accessing data indicative of power allocation in the processor to instruction-executing cores and determining per-core power usage based on the power usage of one or more processors and the power allocation in the processor to instruction-executing cores.

Example 20 includes one or more examples, wherein the determining power usage per virtualized execution environment executing on the processor based on the power usage data comprises: determining per virtualized execution environment based on the determined per-core power usage and the number of virtualized execution environments executed by the processor.

1. At least one non-transitory computer-readable medium comprising instructions stored thereon, that if executed by one or more processors, cause the one or more processors to:
receive power usage data of a platform, the power usage data comprising an identifier of a processor that executes at least two virtualized execution environments, power usage of the processor, and number of virtualized execution environments executed by the processor, wherein at least one virtualized execution environment of the at least two virtualized execution environments comprises a virtual machine and/or container and wherein the at least one virtualized execution environment is to execute a virtualized network function;
determine power usage per virtualized execution environment executing on the processor based on the power usage data; and
output the power usage per virtualized execution environment executing on the processor.

2. The at least one non-transitory computer-readable medium of claim 1, wherein the power usage data comprises one or more of: power usage of one or more processors, processor utilization by a workload, processor stock-keeping unit (SKU) identifier, or identifiers of virtualized execution environments that execute on at least one physical processor.

3. The at least one non-transitory computer-readable medium of claim 1, wherein the power usage data comprises one or more of: supplied power, temperature, or fan speeds.

4. The at least one non-transitory computer-readable medium of claim 1, wherein the determine power usage per virtualized execution environment executing on the processor based on the power usage data comprises:
access data indicative of power allocation in the processor to instruction-executing cores and
determine per-core power usage based on the power usage of one or more processors and the power allocation in the processor to instruction-executing cores.

5. The at least one non-transitory computer-readable medium of claim 4, wherein the determine power usage per virtualized execution environment executing on the processor based on the power usage data comprises:
determine per virtualized execution environment based on the determined per-core power usage and the number of virtualized execution environments executed by the processor.

6. The at least one non-transitory computer-readable medium of claim 1, wherein the processor comprises one or more of: central processing unit (CPU), graphics processing unit (GPU), or accelerator.

7. The at least one non-transitory computer-readable medium of claim 1, wherein the output the power usage per virtualized execution environment executing on the processor comprises cause display in a graphics user interface of the power usage per virtualized execution environment executing on the processor and one or more of: carbon usage of the at least two virtualized execution environments, power usage by the at least two virtualized execution environments, or number of executed virtualized execution environments.

8. The at least one non-transitory computer-readable medium of claim 1, wherein the at least two virtualized execution environments comprise a virtual network function (VNF) or a cloud native network function (CNF).

9. An apparatus comprising:
a memory and at least one processor, that based on execution of at least one instruction stored in the memory, is to:
access power usage data of a platform, the power usage data comprising an identifier of a processor that executes at least two virtualized execution environments, power usage of the processor, and number of virtualized execution environments executed by the processor, wherein at least one virtualized execution environment of the at least two virtualized execution environments comprises a virtual machine and/or container and wherein the at least one virtualized execution environment is to execute a virtualized network function;
determine power usage per virtual execution environment executing on the processor based on the power usage data; and
output the power usage per virtual execution environment executing on the processor.

10. The apparatus of claim 9, wherein the power usage data comprises one or more of: power usage of one or more processors, processor utilization by a workload, processor stock-keeping unit (SKU) identifier, or identifiers of virtualized execution environments that execute on at least one physical processor.

11. The apparatus of claim 9, wherein the power usage data comprises one or more of: supplied power, temperature, or fan speeds.

12. The apparatus of claim 9, wherein the determine power usage per virtualized execution environment executing on the processor based on the power usage data comprises:
access data indicative of power allocation in the processor to instruction-executing cores and
determine per-core power usage based on the power usage of one or more processors and the power allocation in the processor to instruction-executing cores.

13. The apparatus of claim 12, wherein the determine power usage per virtualized execution environment executing on the processor based on the power usage data comprises:
determine per virtualized execution environment based on the determined per-core power usage and the number of virtualized execution environments executed by the processor.

14. The apparatus of claim 9, wherein the processor comprises one or more of: central processing unit (CPU), graphics processing unit (GPU), or accelerator.

15. The apparatus of claim 9, wherein the output the power usage per virtualized execution environment executing on the processor comprises cause display in a graphics user interface of the power usage per virtualized execution environment executing on the processor and one or more of: carbon usage of the virtualized execution environments, power usage by the virtualized execution environments, or number executed virtualized execution environments.

16. The apparatus of claim 9, wherein the virtualized execution environments comprise a virtual network function (VNF) or a cloud native network function (CNF).

17. A method comprising:
accessing power usage data of a platform, the power usage data comprising an identifier of a processor that executes at least two virtualized execution environments, power usage of the processor, and number of virtualized execution environments executed by the processor, wherein at least one virtualized execution environment of the at least two virtualized execution environments comprises a virtual machine and/or container and wherein the at least one virtualized execution environment executes a virtualized network function;
determining power usage per virtualized execution environment executing on the processor based on the power usage data; and
providing the power usage per virtualized execution environment executing on the processor.

18. The method of claim 17, wherein the power usage data comprises one or more of: power usage of one or more processors, processor utilization by a workload, processor stock-keeping unit (SKU) identifier, or identifiers of virtualized execution environments that execute on at least one physical processor.

19. The method of claim 17, wherein the determining power usage per virtualized execution environment executing on the processor based on the power usage data comprises:
accessing data indicative of power allocation in the processor to instruction-executing cores and
determining per-core power usage based on the power usage of one or more processors and the power allocation in the processor to instruction-executing cores.

20. The method of claim 19, wherein the determining power usage per virtualized execution environment executing on the processor based on the power usage data comprises:
determining per virtualized execution environment based on the determined per-core power usage and the number of virtualized execution environments executed by the processor.
